(19) United States
(12) Patent Application Publication
(10) Pub. No.: US 2026/0266691 A1
(43) Pub. Date: Sep. 10, 2026

(54) SENSOR SYSTEM AND METHOD FOR STRUCTURAL HEALTH MONITORING OF MOBILE EQUIPMENT

(71) Applicant: RealSense AI, Inc., Fort Mill, SC (US)

(72) Inventors: James M. INGERSLEW, Tega Cay, SC (US); Aaron Kistler, Houston, TX (US); Alan Hartman, Louisa, VA (US)

(21) Appl. No.: 19/562,265

(22) Filed: Mar. 10, 2026

Related U.S. Application Data
(60) Provisional application No. 63/769,544, filed on Mar. 10, 2025.

(51) Int. Cl. G01M 13/045

(52) U.S. Cl. CPC G01M 13/045

(57) ABSTRACT

A sensor system for monitoring mobile equipment operating on a substrate, comprising: an accelerometer configured to detect impacts on the mobile equipment caused by periodic spaces and/or bumps and/or depressions and/or any other irregularity on the substrate; a microcontroller operatively coupled to the accelerometer and configured to a) identify impacts exceeding a predetermined minimum magnitude, b) measure the time intervals between successive impacts, c) detect a pattern of regularity in the time intervals, and d) trigger the sensor system to collect a data sample at a predetermined time just before an anticipated impact based on the detected pattern; and associated sensing elements configured to provide additional data, wherein the microcontroller is further configured to analyze the collected data to identify defect patterns in rolling elements of the mobile equipment or the substrate.

### RELATED APPLICATION

This application claims the benefit of priority under 35 USC § 119(e) of U.S. Provisional Patent Application No. 63/769,544 filed on Mar. 10, 2025, the contents of which are incorporated herein by reference in their entirety.

### FIELD OF THE INVENTION

The present invention, in some embodiments thereof, relates to equipment maintenance and, more particularly, but not exclusively, to systems and methods for monitoring equipment health.

### BACKGROUND OF THE INVENTION

Railroad wheels endure brutal cyclic loads that spawn invisible fatigue cracks, and wheel crack failures on railroads are one of the top three causes of severe derailments. These incidents are particularly severe because a wheel failure causes the rail car to drop (or dig) into the ground, resulting in an abrupt and severe reduction in speed that rapidly pulls the adjacent cars along with it. Any of these cars may be carrying hazardous materials.

Present inspection methods include visual, ultrasonic, and water based ultrasonic routines that require pulling cars into a bay, applying an ultrasonic couplant spray (or gel if water based), and scanning with handheld probes. This is performed on differing schedules based on railroad maintenance schedules and may be done as infrequently as once every 5 years. Fatigue often advances faster than this interval allows, resulting in cracks that escape notice until catastrophic failure.

### SUMMARY OF THE INVENTION

According to an aspect of some embodiments of the present invention there is provided a sensor system for monitoring mobile equipment operating on a substrate, comprising: an accelerometer configured to detect impacts on the mobile equipment caused by periodic spaces and/or bumps and/or depressions and/or any other irregularity on the substrate; a microcontroller operatively coupled to the accelerometer and configured to a) identify impacts exceeding a predetermined minimum magnitude, b) measure the time intervals between successive impacts, c) detect a pattern of regularity in the time intervals, and d) trigger the sensor system to collect a data sample at a predetermined time just before an anticipated impact based on the detected pattern; and associated sensing elements configured to provide additional data, wherein the microcontroller is further configured to analyze the collected data to identify defect patterns in rolling elements of the mobile equipment or the substrate.

In an embodiment of the invention, the microcontroller is further configured to determine whether a data sample is required based on additional factors, including load magnitude or operational status of the mobile equipment.

In an embodiment of the invention, the substrate comprises pavement, rail, or water, or any combination thereof, with periodic irregularities.

In an embodiment of the invention, the accelerometer is affixed to a bearing carrier of a railroad bearing assembly.

According to an aspect of some embodiments of the present invention there is further provided a method of using a sensor system for monitoring mobile equipment operating on a substrate, comprising: entering a low power mode; detecting impacts on the mobile equipment with an accelerometer to activate the system; using a microcontroller to switch the accelerometer to high sampling rate to capture vibration-related data resulting from the impacts; processing the vibration-related data to determine a measured indication of frequency shift; and, communicating the measured indication of frequency shift for fleet analysis.

In an embodiment of the invention, the accelerometer monitors for impacts exceeding 5 g peak amplitude at a reduced sampling rate of 100 samples per second.

In an embodiment of the invention, switching occurs when time intervals between detected impacts varies by less than 5%.

In an embodiment of the invention, high-rate sampling is at least 15,000 samples per second.

In an embodiment of the invention, the microcontroller triggers a local alert if the measured frequency shifts downward by more than 2% from a baseline, indicating a potential or impending equipment failure.

In an embodiment of the invention, the method further comprises calibrating the system by impacting the mobile equipment to prompt the accelerometer to identify dominant natural frequency peaks within a pre-configured range to establish a baseline.

In an embodiment of the invention, the accelerometer truncates a captured waveform from the impact to include data from 5 milliseconds pre-impact to the point where vibrations attenuate to within 0.01 g of a noise floor.

In an embodiment of the invention, the method further comprises applying a rectangular window function.

In an embodiment of the invention, the method further comprises applying a Fast Fourier Transform to identify at least one natural frequency peak.

In an embodiment of the invention, the pre-configured range is 500-2000 Hz.

In an embodiment of the invention, the processing comprises applying a rectangular window function, applying a Fast Fourier Transform and identifying at least one natural frequency.

In an embodiment of the invention, the method further comprises fusing data collected from a temperature sensor to account for thermal expansion effects on the mobile equipment being sampled.

In an embodiment of the invention, accounting for thermal expansion effects includes using a linear correction factor.

In an embodiment of the invention, impacting is performed by impacting a rail car wheel bearing, vehicle tire side wall, an amusement ride wheel bearing or a wheel tread.

In an embodiment of the invention, the method further comprises storing the at least one of the baseline and the measured indication of frequency shift.

In an embodiment of the invention, the system is used for diagnosing at least one of rotating elements or structural elements of the mobile equipment or the substrate.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIGS. 1A-1B are an illustration of a sensor system components for collecting the data appropriately, in accordance with an exemplary embodiment of the invention;

FIGS. 2A-2B are an illustration of a wheel, axle, bearing, and bearing carrier system architecture, in accordance with an exemplary embodiment of the invention;

FIGS. 3A-3B are an illustration of a naturally occurring or intentionally created bumps or joints that create impacts, in accordance with an exemplary embodiment of the invention; and,

FIG. 4 is a flowchart showing exemplary processing steps executed by the sensor's firmware, in accordance with an exemplary embodiment of the invention.

### DESCRIPTION OF SPECIFIC EMBODIMENTS OF THE INVENTION

The present invention, in some embodiments thereof, relates to equipment maintenance and, more particularly, but not exclusively, to systems and methods for monitoring equipment health.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Generally, the disclosed system attaches to the wheel itself on the bearing adapter, borrows the free hammer-blows already delivered by every rail joint, and samples the response vibration many times per trip, or thousands of times per year, versus as little as once every five years with conventional procedures. This improves crack detection warning times by several orders of magnitude.

A compact sensor containing a MEMS accelerometer is affixed to a rail car wheel bearing carrier and exploits the natural hammer blows delivered by naturally occurring or intentionally created joints, bumps, or other acceleration inducing feature. After initial calibration—for example, struck once by a ball-peen hammer—the unit stores the wheel's natural frequencies. In service, it passively monitors for impact periodicity, shifts to high sample rate mode to record subsequent impacts, computes the FFT, and compares the response frequencies to the baseline (measured when the calibration process is performed). A consistently measured frequency shift toward zero triggers an on-board alert; data packets upload for cloud-level trending.

Sampling for the defect optionally occurs thousands of times per year versus as little as once every five years. Additionally, these manual ultrasonic readings require special equipment and facilities. This method takes advantage of the events that occur during normal operation and leads to fewer catastrophic derailments in the railroad industry as an example.

In an embodiment of the invention, the inventive system measures the fixed-time cycle of track joint, predicts the next impact time, switches to high-rate recording, captures the full vibration impact response waveform, performs a Fast Fourier Transform (FFT) calculation, and identifies the wheel's selected natural frequency. A hammer impact calibration baseline allows selection of specific natural frequency mode for later monitoring. These modes are defined as a plurality of frequencies. If the selected natural frequency mode shifts to a lower frequency in future monitoring an on-board alarm can be triggered. Data from these tests can upload as they occur to the cloud for fleet-wide trending and trigger human review. In this way inspections occur as often as the asset is operated thereby catching potentially catastrophic failure long before it happens and long before its next inspection.

A sensor assembly, according to an embodiment of the invention, consists of a MEMS accelerometer capable of sampling at a minimum of 25,000 samples per second. It is affixed to the wheel hub or bearing carrier using high-strength epoxy adhesive or a mechanical fastener and is electrically connected to an ARM-based microcontroller operating at 2.0-3.3 volts. A discrete Hall-effect sensor is also optionally monitored simultaneously by the microcontroller.

Detection of a magnet by the Hall-effect sensor triggers calibration mode for the combined MEMS sensor and microcontroller system. Entry into calibration mode is indicated to the user by a distinct change in LED behavior.

In calibration mode, the MEMS sensor begins sampling at a configurable rate of 7,500 to 25,000 samples per second (adjusted to suit different types and designs). An operator then delivers a single, controlled impact to the wheel tread or rim using a standardized ball-peen hammer. The sensor continues sampling until the impact-induced vibration attenuates to near the noise floor.

The captured time waveform is optionally truncated to include only the interval from a few milliseconds before the impact to the point where the signal returns to noise-floor levels. A window function (such as a uniform/rectangular window or another suitable type) is applied to the impact vibration response waveform, followed by computation of a FFT. The dominant frequency (or frequencies) and their corresponding amplitudes are identified, stored in non-volatile memory, and transmitted via the communications interface. Expected dominant frequencies vary by wheel type and design; specific frequency ranges are configured to guide the sensor in locating and recording the relevant peak(s).

Once the calibration data has been successfully transmitted and acknowledged, the LED behavior changes to indicate that calibration is complete. The acknowledgment may come from a local monitoring device or from a cloud-based monitoring device.

Normal operational monitoring then begins. The MEMS sensor enters a low-power sleep mode while simultaneously monitoring for periodic impact events. Impacts occurring at periodic intervals detected using a configurable low amplitude threshold determined to be at typical rail joint intervals of 30 to 45 feet for railroads but could be other distances depending on industry and specific application. The detection amplitude of these impact spikes is also configurable, ranging from 1.5 to 50 times the baseline acceleration (g's, peak) value to accommodate various wheel designs and operating parameters.

Upon detecting three consecutive impacts with interval variation of less than 8%, the microcontroller locks in the measured interval, activates the appropriate sampling rate and recording parameters established during calibration, and begins capturing data prior to the next impact to capture the entire impact response vibration. The recorded time waveform is processed identically to the calibration procedure: an appropriate window function is applied to the digitized vibration response data, a FFT is computed, and the impact induced natural frequencies are extracted within the same frequency ranges used during calibration.

The resulting natural frequency impact response measurement(s) are saved locally. The sensor can then:
Option A: Compare the in-operation measured frequency value(s) to the stored baseline calibration frequencies. If the in-operation measured natural frequencies are lower frequencies than those measured in the calibration mode (indicating a potential wheel crack) then a local alert may be triggered.
Option B: Transmit the new measurement(s) via the wireless data path to a central monitoring system.
Or perform both actions.

In any case, notifications can be provided locally (via LED patterns, or other annunciator methods) and/or remotely (via email, phone call, online portal, or other channels). Cloud-based analytics can track average fleet trends, detect anomalies, and alert engineers when human intervention is required.

### EXAMPLES

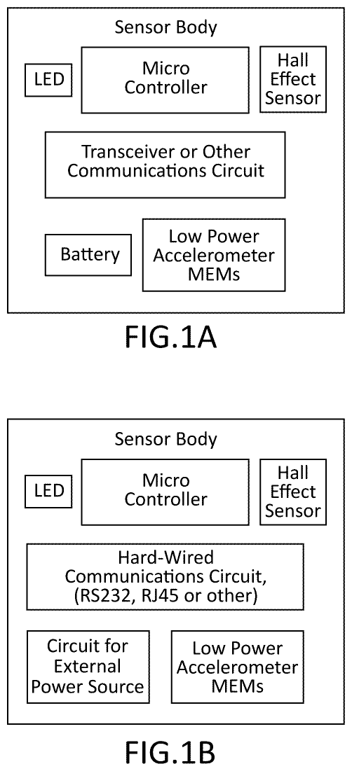

The following example scenarios illustrate representative implementations of the systems and methods described herein and are consistent with the architectures and processes shown in FIGS. 1A-4. These examples are provided solely to demonstrate practical application of the disclosed concepts and are not intended to limit the scope of the invention, additionally, hardware and processes described with example could conceivably be used in one or more of the other examples.

### Example 1—Basic Railroad Wheel Crack Detection System

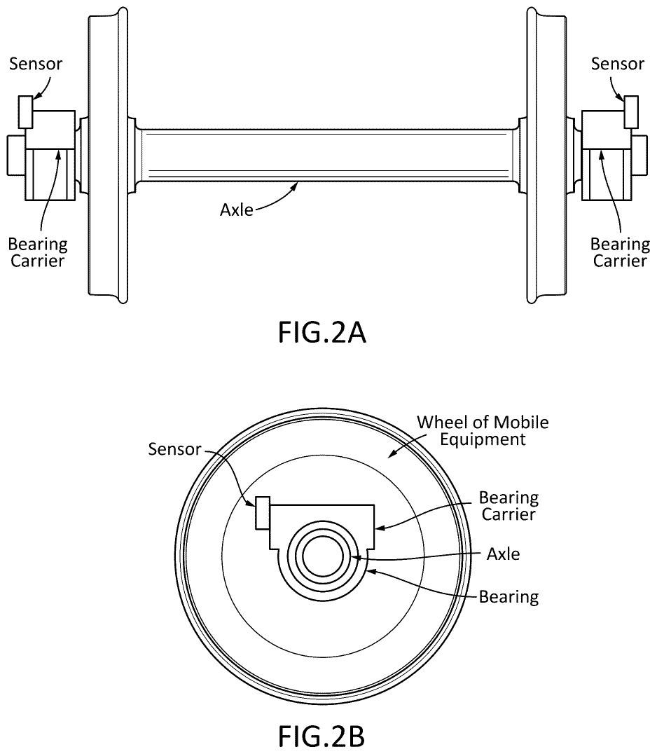

In one exemplary embodiment, as illustrated in FIGS. 1A-1B, the sensor system comprises a self-contained unit including a MEMS accelerometer capable of sampling at rates up to 25,000 samples per second, affixed to the bearing carrier of a railroad bearing assembly, as shown in FIGS. 2A-2B. The accelerometer is operatively coupled to an ARM-based microcontroller operating at 2.4 volts, powered by a lithium-ion battery with an expected lifespan of at least 5 years under normal operating conditions. A Hall-effect sensor is optionally integrated into the assembly and monitored by the microcontroller to initiate calibration mode upon detection of a calibration magnet placed near the unit by an operator.

During calibration, the operator places the magnet to trigger the Hall-effect sensor, causing the microcontroller to activate an LED indicator to flash rapidly, signaling entry into calibration mode. The MEMS accelerometer then samples at 15,000 samples per second while the operator delivers a single impact to the wheel rim using a 16-ounce ball-peen hammer. The captured waveform is truncated to include data from 5 milliseconds pre-impact to the point where vibrations attenuate to within 0.01 g of the noise floor. A rectangular window function is applied, followed by a 1024-point FFT computation. The microcontroller identifies the dominant natural frequency peaks within a pre-configured range of 500-2000 Hz (typical for standard 36-inch railroad wheels) and stores it in non-volatile flash memory. Upon successful storage and transmission via a Bluetooth Low Energy (BLE) interface to a handheld device for acknowledgment, the LED switches to a steady glow, indicating calibration completion.

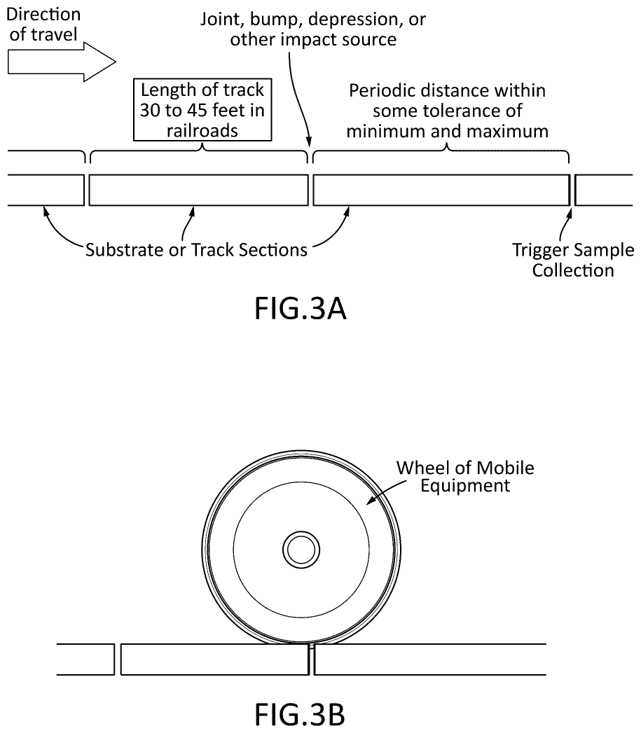

In normal operation, the system enters a low-power mode, with the accelerometer monitoring for impacts exceeding 5 g peak amplitude at a reduced sampling rate of 100 samples per second. As depicted in FIGS. 3A-3B, rail joints spaced approximately 39 feet apart create periodic impacts as the wheel traverses the track. Upon detecting three consecutive impacts with time intervals varying by less than 5% (e.g., at train speeds of 40 mph, intervals of about 0.66 seconds), the microcontroller predicts the next impact and switches to high-rate sampling (15,000 samples per second) starting 10 milliseconds prior. The captured data is processed identically to calibration: windowed, FFT-computed, and the natural frequency extracted.

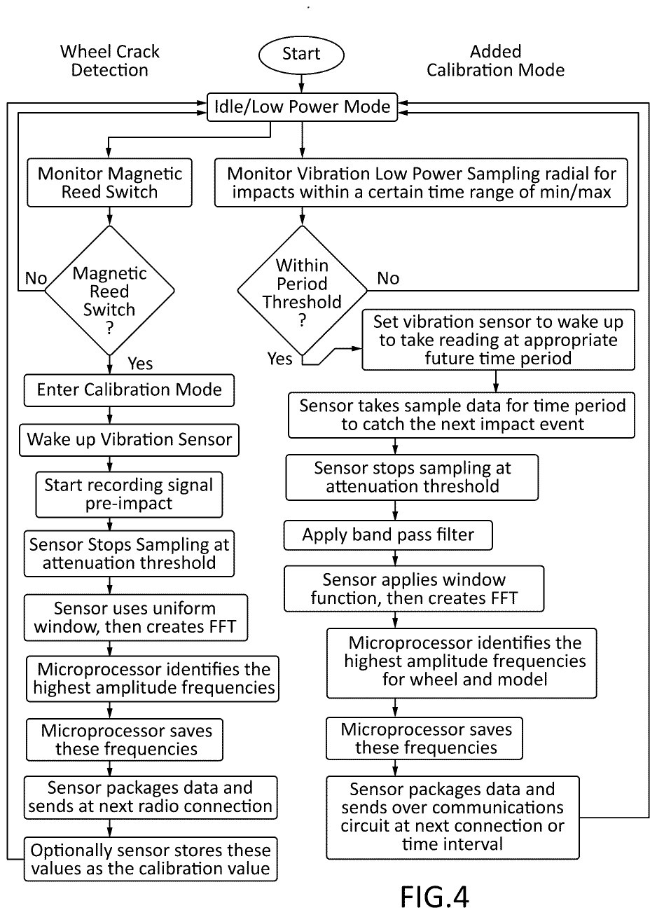

If the measured frequency shifts downward by more than 2% from the baseline (indicating potential crack initiation), the microcontroller triggers a local alert via the LED flashing in a specific pattern and transmits the data packet—including timestamp, frequency value, and amplitude—via the BLE interface to a gateway device on the rail car, which uploads to a cloud server for fleet analysis. The flowchart in FIG. 4 outlines one, some or all of the action steps of this process: start, calibration detection, calibration processing, normal monitoring, impact pattern detection, data capture and analysis, comparison and alert, and data transmission. Not all of the steps show, or additional steps, may be implemented as a part of the process shown in FIG. 4.

This embodiment is particularly suited for freight railroads, where wheels experience high cyclic loads and potential catastrophic derailments of hazardous materials.

### Example 2—Enhanced System With Mechanical Fastening and Multi-frequency Monitoring

In another exemplary embodiment, the sensor assembly is mounted using mechanical fasteners (e.g., M6 bolts) instead of epoxy (although epoxy could still be used), allowing for easier removal and reinstallation during maintenance. This is advantageous for passenger rail applications where wheels are inspected more frequently. The microcontroller is configured to monitor multiple natural frequency modes (e.g., the first three dominant peaks in the 300-2500 Hz range) during both calibration and operation, storing a vector of frequencies and amplitudes in memory.

Calibration proceeds similarly, but with a configurable sampling rate of 20,000 samples per second and a Hann window function applied to reduce spectral leakage in the FFT. In operation, impacts from rail joints or intentional substrate irregularities (e.g., welded sections) are detected with a threshold of 10 g, accommodating higher-speed trains up to 80 mph. If any of the monitored frequencies shift lower by 1-5% (configurable via firmware update), the system performs Option

A (local comparison and alert) and Option B (transmission via cellular modem 85 integrated in place of BLE for remote areas).

Additional data from a temperature sensor (e.g., a thermistor) is fused into the analysis: frequency measurements are temperature-compensated using a linear correction factor (e.g., +0.01% per ° C. above 20° C.) to account for thermal expansion effects on wheel resonance. Cloud analytics track fleet-wide trends, such as average frequency shifts across similar wheel types, and flag outliers for human review via an online dashboard.

Referring to FIGS. 2A-2B, this embodiment positions the sensor on the inboard side of the bearing carrier to minimize exposure to debris, enhancing durability in harsh environments like coal-hauling operations.

### Example 3—Application on Non-railroad Mobile Equipment

This exemplary embodiment adapts the system for off-highway mining trucks operating on unpaved haul roads with periodic potholes or grader-created ridges serving as impact sources (analogous to rail joints in FIGS. 3A-3B). The sensor is mounted on the wheel hub of a 240-ton capacity truck, with sampling rates adjusted to 10,000 samples per second to capture lower-frequency vibrations (100-1000 Hz) typical of larger, rubber-tired wheels.

Calibration uses a sledgehammer impact on the vehicle tire sidewall, triggered without a Hall-effect sensor but via a button press on the unit. The microcontroller detects impact patterns from road irregularities spaced 20-50 feet apart, with intervals varying by less than 10% at speeds of 20-30 mph. Data analysis includes pattern recognition for defects in wheel rims, bearings, or even substrate issues like soft spots in the roadbed.

Power is harvested from wheel rotation via a piezoelectric generator, extending battery life indefinitely. Alerts are transmitted via satellite link for remote mining sites, and local notifications use an audible buzzer. The flowchart in FIG. 4 applies with modifications: impact thresholds set to 1.5 times the baseline acceleration to suit softer substrates and pneumatic tires.

This embodiment detects rim cracks, preventing downtime in continuous operations, and/or can integrate with vehicle telematics for real-time fleet monitoring.

### Example 4—Amusement Park Ride Wheel Monitoring

For amusement park rides, the system is optionally miniaturized with a 3.3-volt microcontroller and accelerometer sampling at 12,500 samples per second. Mounted on ride or roller coaster wheel bearings, it exploits track joints or expansion gaps as impact sources.

Calibration occurs during off-hours with a ball-peen hammer applied to the ride or roller coaster wheel bearings. Operation detects patterns at ride speeds of 50-70 mph, with thresholds of 15 g. Frequency monitoring focuses on 800 -1800 Hz for lightweight alloy or hard urethane wheels. Alerts trigger immediate ride shutdown via wired interface to control systems, preventing accidents from fatigue cracks.

Cloud trending analyzes seasonal variations due to temperature and load, enhancing safety in high-cycle environments.

### Example 5—Underground Mining Vehicle Wheel Monitoring System

In another exemplary embodiment, the sensor system is adapted for use on subsurface mining vehicles equipped with non-pneumatic, solid rubber wheels, such as Load-Haul-Dump (LHD) machines or shuttle cars commonly used in underground coal or hard rock mining operations. These vehicles operate on uneven tunnel floors or haulage ways that may include periodic irregularities like rock fragments, drainage grates, or intentional substrate features (e.g., speed bumps or rail crossings in hybrid systems), which serve as natural impact sources analogous to rail joints in FIGS. 3A-3B. This application aligns the embodiments for mining equipment and for substrates with periodic irregularities, enabling diagnosis of potential or impending equipment failures such as wheel rim cracks, hub failures, and/or substrate issues.

The sensor assembly includes a ruggedized MEMS accelerometer rated for high-shock environments (up to 500 g), mounted on the wheel hub or bearing carrier using mechanical clamps or bolts to withstand abrasive dust and moisture typical in underground settings. The accelerometer is coupled to a low-power ARM-based microcontroller operating at 3.3 volts, powered by a sealed lithium-thionyl chloride battery designed for extended life (up to 10 years) in low-temperature, high-humidity conditions. An optional integrated temperature and humidity sensor provides environmental data to compensate for variations in vibration responses.

Calibration mode is initiated via a wireless interface (e.g., BLE) from a handheld device, as physical access may be limited in confined tunnels. The operator delivers a controlled impact to the wheel tread using a mining-approved non-sparking hammer while the vehicle is stationary. The accelerometer samples at 10,000 samples per second, capturing the waveform from 5 milliseconds pre-impact until attenuation to 0.05 g above the noise floor. A Hanning window is applied, followed by a 512-point FFT to identify dominant natural frequencies in the 200 -1200 Hz range, typical for solid rubber wheels on 20-40 ton LHD machines. These baseline frequencies and amplitudes are stored in non-volatile memory.

In normal operation, the system monitors in low-power mode at 50 samples per second for impacts exceeding 2 times the baseline acceleration, reflecting the lower speeds (5-15 mph) and softer impacts from mine floor irregularities spaced 10-30 feet apart. Upon detecting a pattern of three consecutive impacts with intervals varying by less than 10% (accounting for variable terrain), the microcontroller predicts the next impact and switches to high-rate sampling to capture the full response. The data is processed as in calibration: windowed, FFT-computed, and frequencies extracted.

If a downward frequency shift of 3% or more is detected (indicating potential cracks in the steel rim or delamination in the solid rubber), the system triggers a local alert via a high-visibility LED with a strobe pattern and/or an audible buzzer integrated for noisy environments. Simultaneously, data packets—including frequency values, timestamps, and environmental readings—are transmitted via a robust wireless protocol (e.g., LoRa or WiFi mesh) to a central mine monitoring system for cloud-based trending. Sampling decisions can incorporate load magnitude data from an optional strain gauge or operational status via CAN bus integration with the vehicle's ECU.

The flowchart in FIG. 4 applies with adaptations: impact detection uses configurable thresholds for mine-specific substrates, and alerts prioritize safety shutdowns to prevent wheel failures in explosive or confined areas. This embodiment enhances reliability in underground mining by providing frequent, passive inspections, reducing the risk of equipment breakdowns that could lead to production halts or safety incidents.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A sensor system for monitoring mobile equipment operating on a substrate, comprising:
an accelerometer configured to detect impacts on the mobile equipment caused by periodic spaces and/or bumps and/or depressions and/or any other irregularity on the substrate;
a microcontroller operatively coupled to the accelerometer and configured to
a) identify impacts exceeding a predetermined minimum magnitude,
b) measure the time intervals between successive impacts,
c) detect a pattern of regularity in the time intervals, and
d) trigger the sensor system to collect a data sample at a predetermined time just before an anticipated impact based on the detected pattern; and
associated sensing elements configured to provide additional data, wherein the microcontroller is further configured to analyze the collected data to identify defect patterns in rolling elements of the mobile equipment or the substrate.

2. The sensor system of claim 1, wherein the microcontroller is further configured to determine whether a data sample is required based on additional factors, including load magnitude or operational status of the mobile equipment.

3. The sensor system of claim 1, wherein the substrate comprises pavement, rail, or water, or any combination thereof, with periodic irregularities.

4. The sensor system of claim 1, wherein the accelerometer is affixed to a bearing carrier of a railroad bearing assembly.

5. A method of using a sensor system for monitoring mobile equipment operating on a substrate, comprising:
entering a low power mode;
detecting impacts on the mobile equipment with an accelerometer to activate the system;
using a microcontroller to switch the accelerometer to high sampling rate to capture vibration-related data resulting from the impacts;
processing the vibration-related data to determine a measured indication of frequency shift; and,
communicating the measured indication of frequency shift for fleet analysis.

6. The method according to claim 5, wherein the accelerometer monitors for impacts exceeding 5 g peak amplitude at a reduced sampling rate of 100 samples per second.

7. The method according to claim 5, wherein switching occurs when time intervals between detected impacts varies by less than 5%.

8. The method according to claim 5, wherein high-rate sampling is at least 15,000 samples per second.

9. The method according to claim 5, wherein the microcontroller triggers a local alert if the measured frequency shifts downward by more than 2% from a baseline, indicating a potential or impending equipment failure.

10. The method according to claim 5, further comprising calibrating the system by impacting the mobile equipment to prompt the accelerometer to identify dominant natural frequency peaks within a pre-configured range to establish a baseline.

11. The method according to claim 10, wherein the accelerometer truncates a captured waveform from the impact to include data from 5 milliseconds pre-impact to the point where vibrations attenuate to within 0.01 g of a noise floor.

12. The method according to claim 11, further comprising applying a rectangular window function.

13. The method according to claim 12, further comprising applying a Fast Fourier Transform to identify at least one natural frequency peak.

14. The method according to claim 10, wherein the pre-configured range is 500-2000 Hz.

15. The method according to claim 5, wherein the processing comprises applying a rectangular window function, applying a Fast Fourier Transform and identifying at least one natural frequency.

16. The method according to claim 5, further comprising fusing data collected from a temperature sensor to account for thermal expansion effects on the mobile equipment being sampled.

17. The method according to claim 16, wherein accounting for thermal expansion effects includes using a linear correction factor.

18. The method according to claim 10, wherein impacting is performed by impacting a rail car wheel bearing, vehicle tire side wall, an amusement ride wheel bearing or a wheel tread.

19. The method according to claim 10, further comprising storing the at least one of the baseline and the measured indication of frequency shift.

20. The method according to claim 5, the system is used for diagnosing at least one of rotating elements or structural elements of the mobile equipment or the substrate.
